(19) United States
(12) Patent Application Publication
(10) Pub. No.: US 2015/0039407 A1
(43) Pub. Date: Feb. 5, 2015

(54) Mobile Application Based Advertisement System and Method

(71) Applicant: Ming Liu, Yun Cheng (CN)

(72) Inventor: Ming Liu, Yun Cheng (CN)

(21) Appl. No.: 14/327,661

(22) Filed: Jul. 10, 2014

Related U.S. Application Data
(60) Provisional application No. 61/861,239, filed on Aug. 1, 2013.

(51) Int. Cl. G06Q 30/02

(52) U.S. Cl. CPC G06Q 30/0239; G06Q 30/0267
USPC 705/14.12; 705/14.39

(57) ABSTRACT

Disclosed is a system and method for incorporating advertisements into a mobile application for computerized systems, and in particular, mobile devices. In one embodiment of the invention, the system comprises an entertaining game application, a tool application, or a utility application that features various advertised goods or services, wherein the goods or services may be won and redeemed for an actual equivalent at participating businesses. Alternatively, cash or other prizes may be won or redeemed. In another embodiment, the method provides revenue to mobile application developers based on the inclusion of advertised products or services within the mobile applications, as well as on the number of times an advertisement is displayed. Consumers are incentivized to use the mobile application and engage advertisements because they are rewarded with goods, services, cash, or other prizes from participating businesses. In this way, participating businesses gain consumer awareness and benefit from consumer spending.

### CROSS REFERENCE TO RELATED APPLICATION

This application claims the benefit of U.S. Provisional Application No. 61/861,239 filed on Aug. 1, 2013. The above identified patent application is herein incorporated by reference in its entirety to provide continuity of disclosure.

### BACKGROUND OF THE INVENTION

1. Field of the Invention

The invention is directed to an advertisement system and method. More particularly, the invention relates to a mobile application based advertisement system and method which dynamically delivers and displays advertisement content via a game application on mobile devices, such as cell phones and tablet computers.

The advertising industry has evolved tremendously due to the advent of the computer age, and particularly the internet. The dissemination of information has vastly improved over more traditional means such as print media, television, and radio. Even with the significant improvements in computing and the internet over the past decade, however, the systems, methods, and applications available for advertising on computerized or internet based systems are limited.

For example, current methods of advertising products over the internet via mobile devices utilize static images or short videos displayed in proximity to consumer requested content. Mobile-optimized web sites and applications may display an advertisement on the same screen as news articles, movie theatre information, restaurant reservation information, and the like. Even interactive applications that feature video or game play use static advertising to showcase products to consumers. These methods do not provide the consumer with an incentive to engage the advertising, and are merely passive purchasing suggestions.

Further, traditional advertising methods do not reward consumers for engaging the advertising. Most advertisements are engaged via clicking on the displayed image and permitting redirection of a web browser to the website of the advertising business. This method does not provide the consumer with any reward incentive. These advertisements are often obstructive, are not aesthetically pleasing, and degrade the quality of a consumer's mobile application experience. An advertising method that incentivizes consumers to engage the advertising through entertaining interactions is needed for use in the mobile device environment.

The present invention comprises a mobile application for advertising goods or services on a mobile device. In one embodiment, the system comprises a server and a game application, a tool application, or a utility application wherein the server is in communication with a network, and the application is accessed through a consumer's mobile device that is in communication with the server and the network.

In another embodiment, the invention comprises a method for advertising on a mobile device. This method comprises the steps of creating a mobile application that is installed on a consumer's mobile device. However, it is contemplated that the application may be otherwise accessible to the consumer via the Internet. In this embodiment, one or more participating businesses pay a fee to a mobile application developer to feature their goods and/or services in the application. Additionally, consumers pay a fee to purchase and download the application to their mobile phone or to otherwise access the application. The method may further comprise the step of the consumers viewing the advertisement using the mobile application. Additionally, the consumers may compete for the goods and/or services featured in the application or cash and/or other prizes. In addition, the method may further comprise the step of redeeming prizes won from the mobile application. In this way, the present invention is designed to benefit consumers, mobile device application developers, and advertisers alike. As will be described in further detail herein, there are many additional features of the instant invention.

2. Description of the Prior Art

Devices have been disclosed in the prior art that claim advertisement systems and methods of advertising in a mobile applications. These include systems and methods that have been patented and published in patent application publications, and generally relate to video games on mobile devices. Some of these systems disclose a video game that includes strategically placed advertisements in the virtual environment within the game. Other systems disclose a mobile phone based treasure hunt that provides clues or hints related to a commercial product that lead a player to a destination where the product can be won as a prize or purchased. These systems, however, do not disclose a game application that features advertised goods and/or services that can be obtained or won, then later redeemed. The foregoing is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 7,729,946 to Chu discloses an online game advertising system. In one embodiment, advertising material appears within an online video game as part of the game experience or during idle load, wait, and/or pause screens. The advertising material is adapted to appear transparently without distracting the attention of the game player from the game itself. Thus, the purpose and intent of the online game advertising system of Chu differ from the present invention in that the present invention intends to draw attention of a consumer to the advertising material.

U.S. Pat. No. 8,428,614 to Wolfe discloses a mobile phone mediated treasure hunt game. The game utilizes a system server and at least one mobile phone having a software program that allows a consumer to receive real-time clues with instant feedback and information relating to treasures during the consumer's search. The game enables a consumer to conduct a treasure or scavenger hunt games without requiring a Global Positioning System (GPS) unit. While Wolfe provides a game application for a mobile device to reward the consumer with an actual prize, Wolfe does not disclose a game that incorporates advertisements to benefit participating businesses. Additionally, the advertisements in the game application of Wolfe does not interact with the consumers. The present invention discloses a system and method of advertising using a game application for a mobile device, wherein a participating business can provide in-game advertising for a fee. The game application then advertises goods and/or services to a consumer who is playing the game. In this way, the present invention benefits the participating business, and increases revenue for both the participating business and the mobile application developer.

U.S. Pat. No. 8,156,004 to Wajihuddin discloses a system and method for providing targeted advertisements to a consumer within a virtual environment. The system is adapted to customize the advertisements to feature products and/or services that are preferred by the consumer. In some embodiments, the advertisements may be in the form of virtual offers to a gamer. If a gamer selects one or more of the provided offers, future advertisements are modified to include components associated with the selected offers. While Wajihuddin provides advertisements in game applications, Wajihuddin does not allow consumers to win or obtain goods and/or services provided by participating businesses. In contrast, the present invention allows consumers to compete in a game to win or obtain goods and/or services so that the goods and/or services may be redeemed at participating businesses. Thus, the present invention encourages consumers to actively participate in games to win or obtain goods and/or services rather than to merely purchase them through the game application.

U.S. Pat. No. 6,320,495 to Sporgis discloses a treasure hunt game that utilizes GPS equipped wireless communication devices. The game provides players with clues or directions to proceed along various predetermined treasure hunt routes based on their location as determined by the GPS. In one embodiment, the game may utilize a website as a medium to transmit clues to players and to receive their positions. While the website may provide advertising space to game sponsors, the treasure hunt game does not incorporate goods and/or services from the advertisement. The present invention allows players to win or obtain goods and/or services featured in the game. In this way, the present invention increases brand awareness, benefiting participating businesses.

U.S. Pat. No. 8,199,966 to Guven discloses a system and method for providing product information with animated virtual representations. The system utilizes a mobile device, such as a cell phone, to provide information about the product such as warranties, upgrades, accessories, related products, and the like. In one embodiment, the system may utilize an avatar to communicate with the consumer. Unlike the present invention, however, the system of Guven does not utilize a game application to interact with the consumer to increase brand awareness.

Finally, U.S. Pat. No. 8,407,090 to Kitchen discloses a method for reassigning in-game advertisements within a video game in order to maximize impression counts for the advertisements. The method includes the steps of determining when an advertisement at a first view location is viewed, and incrementing an elapsed time for the advertisement while it is viewed. The method further comprises the steps of calculating an impression count for the advertisement and showing the advertisement until the maximum impression count has been reached. While the method of Kitchen seeks to maximize the impression counts to increase brand awareness, the advertising method of Kitchen is passive. Additionally, Kitchen does not disclose the method of rewarding a consumer with goods and/or services provided by participating businesses. The present invention utilizes an active advertisement method to increase interactive experience that allows consumers to experience goods and/or services. In this way, the present invention increases potential to increase consumer awareness and spending.

The devices disclosed in the prior art have several known drawbacks. These devices are limited in that they comprise relatively static banner advertisements and lack interaction with the consumer. The present invention overcomes these limitations by disclosing a mobile application that features goods and/or services that may be won and later redeemed or received at a participating business. In one embodiment, the game application enables consumers to compete against other consumers or against the computer to obtain a prize that may be in the form of a good or a service. Alternatively, the tool application or the utility application rewards the consumers for viewing featured advertisement by using the application. In this way, the present invention actively advertises various goods and/or services in an entertaining and efficient manner. It is therefore submitted that the present invention is substantially divergent in design elements from the prior art, and consequently it is clear that there is a need in the art for an improvement to advertisement systems and methods of advertising in a mobile application. In this regard, the instant invention substantially fulfills these needs.

### SUMMARY OF THE INVENTION

In view of the foregoing disadvantages inherent in the known types of advertisement systems and methods of advertising in a mobile application now present in the prior art, the present invention provides a new and improved advertisement system and method wherein the same can be utilized for advertising goods and/or services.

It is therefore an object of the invention to provide a new and improved advertisement system and method that has all of the advantages of the prior art and none of the disadvantages.

Another object of the present invention is to provide a new and improved advertisement system and method that utilizes a game application that is accessible on a consumer's mobile device.

Yet another object of the present invention is to provide a new and improved advertisement system and method that benefits mobile application developers and participating businesses while increasing consumer awareness of the participating businesses.

Still yet another object of the present invention is to provide a new and improved advertisement system and method that increases consumer interaction by enabling consumers to compete for and interact with advertised goods and/or services that can later be redeemed.

Still yet another object of the present invention is to provide a new and improved advertisement system and method that is compatible with various types of mobile devices.

Still yet another object of the present invention is to provide a new and improved advertisement system and method that for use with various types of mobile device applications, such as game applications, tool applications, and utility applications, among others.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 depicts a diagram of an embodiment of the system of the present invention.

FIG. 2 depicts a diagram of an exemplary embodiment of the system of the present invention.

FIG. 3 depicts a flow diagram of an embodiment of the method of the present invention.

FIG. 4 depicts a flow diagram of an embodiment of a game application of the present invention.

FIG. 5 depicts a flow diagram of another embodiment of a game application of the present invention.

### DETAILED DESCRIPTION OF THE INVENTION

References are made herein to the attached drawings. Like reference numerals are used throughout the drawings to depict like or similar elements of the advertisement system and method. For the purposes of presenting a brief and clear description of the present invention, the preferred embodiment will be discussed as used for advertising goods and/or services. The figures are intended for representative purposes only and should not be considered to be limiting in any respect.

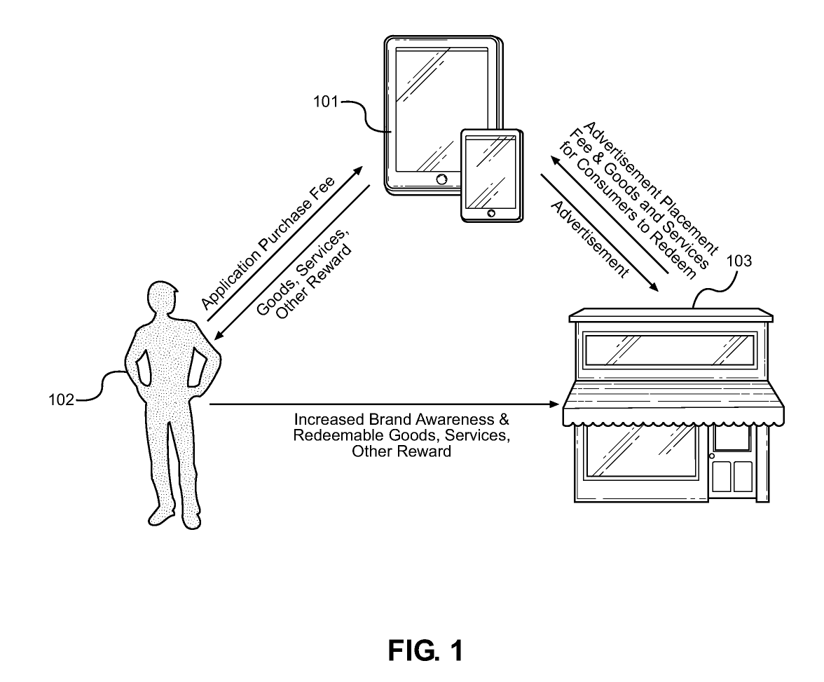

Referring now to FIG. 1, there is shown a diagram of an embodiment of the system of the present invention. The present system comprises a mobile application 101 for a computerized system such as a mobile phone, a tablet computer, or other similar devices having communication means. Without limitation, the mobile application 101 may include a game application, a tool application, or a utility application for a mobile device. For instance, a tool application or a utility application may provide a background wallpaper for a mobile phone, wherein the background wallpaper features advertised goods and/or services. Alternatively, other tool or utility application may comprise a calculator, a clock, and a flashlight, among others. The game application may comprise a wide variety of games and activities such as scavenger hunts, puzzles, races, and contests, among others. The mobile application 101 is capable of featuring goods and/or services provided by participating businesses 103. Additionally, it is contemplated that the mobile application 101 is capable of displaying text, graphics, animation, video, and/or other content related to advertising in the virtual environment within the game application. Thus, the mobile application 101 of the present invention provides versatility to the consumer.

One or more participating businesses 103 or an advertiser interested in featuring their goods and/or services in a particular mobile application 101 may approach the mobile application developer and suggest a good or service for placement within the mobile application 101. The participating businesses 103 or the advertiser may set up a business member account, and pay an advertisement placement fee to the mobile application developer for advertising various goods, services, and/or other prizes in the mobile application 101. The mobile application developer may then include advertisements in the mobile application by offering consumers 102 various types of game play or a tool for a mobile device and the chance to win advertised goods and/or services, cash, or other prizes as reward. In this way, the participating businesses 103 are rewarded with increased interest or awareness of the advertised material, and in some cases, increased consumer influx into their businesses.

Consumers 102 provide revenue to the mobile application developer in the form of application purchase fees, which provides them with interactive and entertaining game play or useful tools as well as the chance to win the advertised goods and/or services, cash, or other prizes. As such, mobile application developers receive revenue streams from both the consumers 102 and participating businesses 103 rather than solely from consumers 102 through application purchases. Additionally, consumers 102 may provide revenue to the mobile application developer in the form of other fees associated with the mobile application 101. For example, a game application may be structured such that consumers 102 may purchase additional attempts at a prize from the mobile application developer through the mobile application 101. The purchase of additional attempts at a prize during the game offer improved chances of winning the game but do not constitute a purchase of any goods or services advertised within the game.

The present invention may also be optionally be enabled to automatically limit the number of advertised goods and/or services that appear in the mobile application 101. Goods and/or services may either alternate with other goods and/or services in a particular game or alternate between various rounds or levels. In this way, different goods and/or services provided by a single participating business 103 may be offered to provide versatility to the consumers 102. The advertised goods and/or services may also be automatically removed from the mobile application 101 after a specified amount of time or when the goods, services, and/or other prizes are no longer offered by the participating businesses 103.

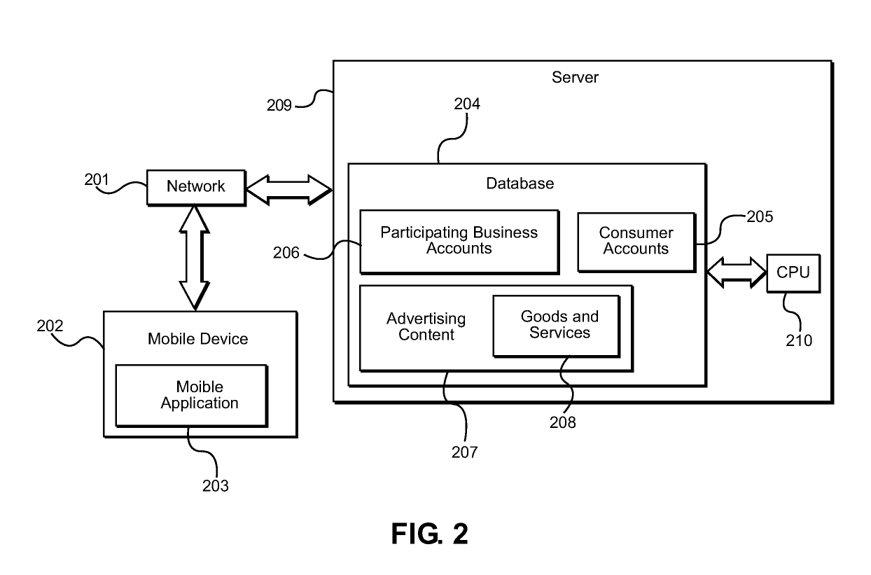

Referring now to FIG. 2, there is shown a diagram of an exemplary embodiment of the system of the present invention. The system of the present invention may be based on any suitable mobile device 202 in communication with a network 201, such as a local area network or a wide area network. Without limitation, the mobile device 202 may include a cell phone, tablet computer, multi-purpose pocket computer, or other similar electronic devices. The mobile device 202 has installed thereon the mobile application 203 of the present invention. A server 209 is in communication with the network 201, and therefore is accessible by the mobile device 202. The server 209 comprises a database 204 and a central processing unit (CPU) 210, wherein the database 204 and the CPU 210 are in communication. Thus, the server 209 is capable of performing two main functions: data processing and data storage. The database 204 comprises data storage and retrieval functionality including participating business accounts 206, consumer accounts 205, and advertising content 207. The advertising content 207 may feature various goods and services 208 provided by the participating business or advertisers. The CPU 210 processes information that is input by the consumer through the mobile application 203, and determines appropriate output information based on the input information. For instance, the CPU 210 is able to determine the number of times the advertising content has been viewed by the consumer, and whether the consumer is eligible for a reward.

The mobile device 202 may enable the consumer using the device to create an account in the mobile application 203 upon installation of the same on the mobile device 202. The consumer account 205 information is then sent via the network 201 to the database 204 for storage. The consumer account 205 keeps a record of the consumer's purchases through the mobile application 203 as well as goods and/or services that have been obtained.

The mobile device 202 also enables the consumer to view advertising content 207 via the mobile application 203. The advertising content 207 may be provided by participating businesses. It is contemplated that the participating businesses may create an account to provide information such as participating business' contact information, payment information, and advertising content 207. Similar to the consumer account 205, the participating business accounts 206 may be stored in the database 204.

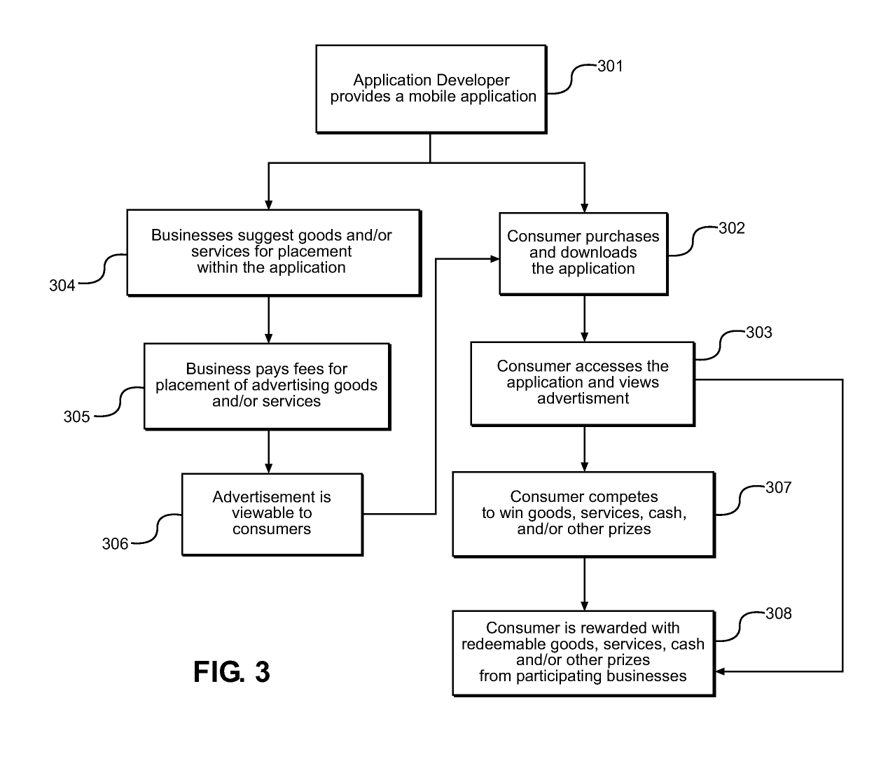

Referring now to FIG. 3, there is shown a flow diagram of an embodiment of the method of integrating the products and services of advertisers onto mobile device applications. In this embodiment, a mobile application developer provides an application with a game platform, a tool platform, or a utility platform for computerized systems such as a mobile phone, a tablet computer, or other similar devices having communication means 301. It is contemplated that the mobile application would be designed to be compatible with various operating systems of a mobile device. The mobile application would then be submitted to an application market place such as a digital distribution platform for mobile applications, application store, or online store. The mobile application may be inspected for compliance with certain guidelines, such as those for quality control and censorship, including the requirement that a commission be collected on each sale of a paid mobile application.

The mobile application may be available to the consumers on the digital distribution platform for mobile applications, application store, or online store, where consumers can browse through different mobile applications, view information about each mobile application, and acquire the application for a predetermined cost 302. Thus, the consumers provide revenue to the mobile application developer in the form of the application purchase costs. The selected mobile application is offered as a download, after which the application installs onto the consumer's mobile device.

The mobile application may be used as an advertising platform for various businesses and advertisers. Interested businesses and advertisers may approach the mobile application developer and suggest goods and/or services for placement within the mobile application 304. In some embodiments, the mobile application may provide means for businesses and advertisers to submit advertising requests. In other embodiments, the businesses and advertisers may approach the mobile application developer directly. The mobile application developer may charge a predetermined fee to place advertisement featuring the suggested goods and/or services based on time, location, and content of the advertisement. Upon payment of fee for placement of advertisements 305, goods and/or services provided by the businesses and advertisers are viewable to the consumers using the mobile application 306. The businesses and advertisers may determine the number of goods, services, and/or other prizes to advertise, as well as the advertising time, which may depend upon the amount of fee paid to place the advertisement.

Once the application is installed or accessed on the consumer's mobile phone, the consumer views the advertisement 303. In a game application, consumers may compete in a game to win or obtain the goods and/or services advertised 307. The consumers may compete with each other, or consumers may compete with a computer. The game may be in a form of a contest, race, or other types of competition as mentioned above. Some game applications may feature an advertised good or service that can be virtually obtained and used during the game so as to provide advantage to the consumer during the gameplay while increasing brand awareness. Virtual goods, services, cash, or other prizes won or obtained during the game play are redeemable for a real equivalent at the advertising business. In other mobile applications such as a tool application or a utility application, consumers may be rewarded with advertised goods, services, cash, or other prizes for viewing the advertisement. For instance, each consumer who views the advertisement can be rewarded with a predetermined amount of cash prize until the cash prize is no longer available. Alternatively, each consumer who views the advertisement can become eligible to enter a lottery to win a cash prize. The consumer may redeem the prize at a store or via the advertising business's website 308. The advertised goods and services are not purchased during the game. Rather, the present invention provides a competitive incentive to obtain the prize advertised, and thereby rewards consumers for game play. Thus, the game application enables consumers to patronize the participating businesses.

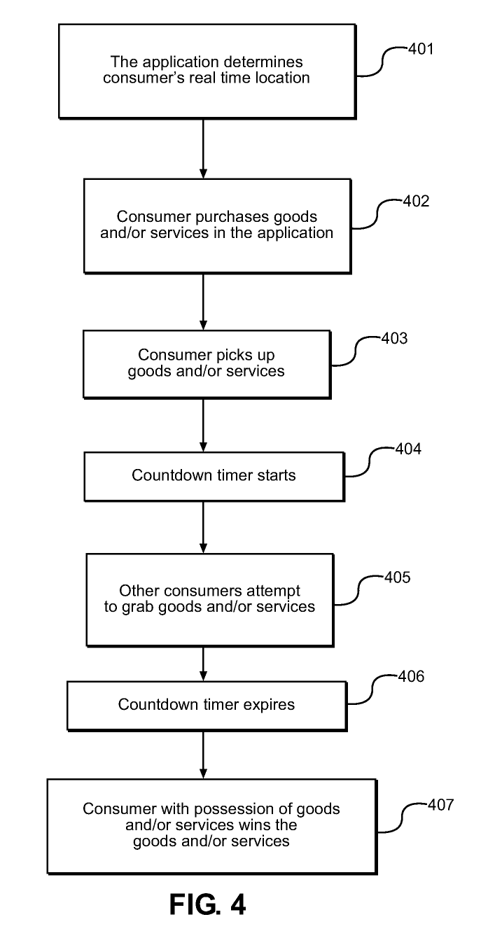

Referring now to FIG. 4, there is shown a flow diagram of an embodiment of a gaming application of the present invention. In this embodiment, the game application may utilize the GPS unit in a mobile device to determine each consumer's real-time position 401. Utilizing the real-time location of the consumer, the game application displays a virtual environment analogous to the consumer's real-time location. For instance, the game application may display a map or a view of nearby streets and buildings of where the consumer is located.

In the illustrated embodiment of the game application, advertised goods and/or services may be available for pick up at various locations in the virtual environment. Each of the advertised goods and/or services may cost a predetermined amount of points that the consumer must expend in order to pick up the goods and/or services. The consumers may go to the various locations in the virtual environment where advertised goods and/or services can be picked up using the game application interface. Every good or service that is purchased 402 and picked up 403 is added to the consumer's bag in the game application.

When a good or a service is added to the consumer's bag, a countdown timer begins counting down a predetermined period of time 404. During the countdown period, other consumers in the surrounding area, or in a location within a predetermined radius of the consumer, of the virtual environment can attempt to steal the good or service from the bag of the consumer who picked up the good or service 405. Consumers may make multiple attempts at grabbing the picked up good or service during the countdown period. Thus, the consumer who originally picked up the good or service may attempt to take the good or service back from the consumer who stole it. Ultimately, goods and/or services may pass through the hands of many consumers before ultimately being assigned to one winner.

The countdown period, as well as the predetermined radius to define the surrounding area, may be predetermined by the mobile application developer. In some embodiments, the countdown period may be undisclosed so that the consumers do not know how much time is left to grab the picked up goods and/or services. When the countdown timer expires 406, the application may be designed to notify the participating consumers, and the grab attempts may be automatically disabled. The consumer who has the possession of the good or service in his or her bag when the countdown timer expires wins the good or service 407. The good or service obtained in the game can then be redeemed at a participating business for the real equivalent. The consumer may then compete again to win another good or service. The game may automatically stop featuring the good or service when it is no longer available or offered by the participating business. Thus, it is contemplated that any number of goods and/or services may be redeemed at a participating business in a given amount of time unless limitations are applied.

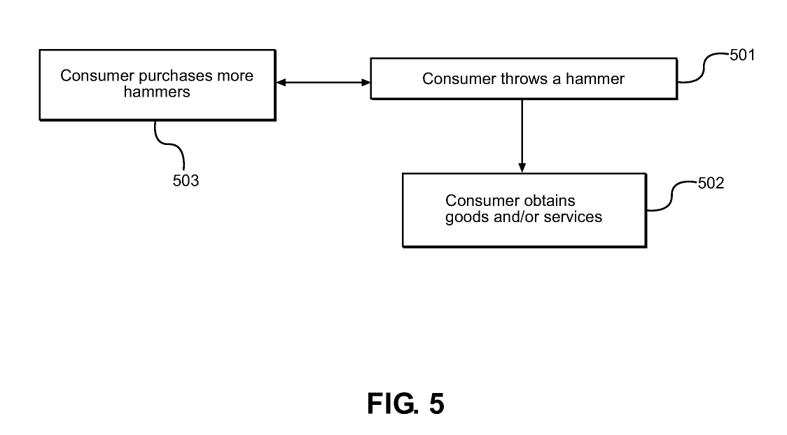

Referring now to FIG. 5, there is shown a flow diagram of another embodiment of a game application of the present invention. In this embodiment, all prizes are encapsulated within eggs or other capsules, wherein consumers are required to crack open the eggs or capsules by casting hammer throws. Each of the eggs or capsules in the game has an assigned hardness value. The hardness value may be predetermined by the mobile application developer. Generally, it is contemplated that the hardness value corresponds to the actual value of the goods or services offered. Additionally, the hardness value of the prizes may be undisclosed so that the consumers do not know the exact number of hammer throws required to open the item.

Each consumer starts the game with a given number of hammer throws. Each hammer throw has a one-time use, and the hardness value of the eggs or capsules is reduced by one point for each successful hammer throw. Thus, the consumer must successfully throw a hammer 501 at the egg or capsule to reveal and win the prize contained therein. In some embodiments, the hammer 501 can represent an advertised good or an advertised service. When the consumer runs out of hammer throws, the consumer may obtain additional hammer throws via the game application for a fee 503. The consumers may take turns in casting hammer throws or throw hammers in a random order. When the hardness value of the eggs or capsules reaches zero, the egg or capsule can crack open, and the consumer who casted the final hammer throw wins the good or service contained in the egg or capsule 502. Similar to the previous embodiment, the goods and/or services obtained in the game can be redeemed at a participating business for equivalent goods and/or services.

Alternatively, the game application may be configured so that the computer randomly chooses one consumer from a group of consumers who casted hammer throws. Consumers can increase the probability of winning by increasing the number of hammer throws. Thus, consumers may purchase more hammer throws 503 in order to increase their chance of winning. Furthermore, the game application may be configured so that the goods and/or services contained in the egg or capsule are revealed before the final hammer throw or remain undisclosed. Similar to the previous embodiment, the consumer may compete numerous times until the goods and/or services are no longer available or offered by the participating business.

Game applications developed using the present system and method provide exposure of goods and services to a wide variety of consumers throughout the course of the game. Each good or service represented as an in-game prize has a real world good or service associated therewith. In this way, participating businesses and advertisers expose numerous consumers to the potential of winning a real-world good or service. This helps to generate interest in the business and the business's product, and provides consumers with exposure to the business's products or services. The present system and method can be adapted to many different mobile platforms and modified to meet the needs of advertisers, consumers, and mobile application developers.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A method for providing advertisement in a mobile application, comprising the steps of:
creating a mobile application adapted to be downloaded and installed on a mobile device;
providing an advertising content featuring a virtual prize in said mobile application in response to an advertisement request by a participating business;
viewing said advertising content in said mobile application;
redeeming said virtual prize for a real equivalent provided by said participating business.

2) The method of providing advertisement of claim 1, wherein said mobile device may comprise a cell phone, a table computer, or a pocket computer.

3) The method of providing advertisement of claim 1, wherein said advertising content is provided by said participating business for a fee.

4) The method of providing advertisement of claim 1, wherein said mobile application is purchased by a consumer for a fee.

5) The method of providing advertisement of claim 1, wherein said mobile application features a game play.

6) The method of providing advertisement of claim 5, further comprising the steps of:
competing for said virtual prize in said game play;
winning said virtual prize in said game play.

7) The method of providing advertisement of claim 5, wherein additional attempts to win said virtual prize during said game play may be purchased by a consumer for a fee.

8) The method of providing advertisement of claim 1, wherein said mobile application features a virtual tool for said mobile device.

9) A system for advertising, comprising:
a network;
a server having a database and a central processing unit;
said server in communication with said network;
one or more mobile devices in communication with said network;
said one or more mobile devices having a mobile application installed thereon;
wherein said mobile application provides advertising content featuring a virtual prize;
wherein said virtual prize is adapted to be rewarded to a consumer of said mobile application;
wherein said virtual prize may be redeemed for an actual equivalent from a participating business.

10) The system for advertising of claim 9, wherein said database comprises at least one participating business account.

11) The system for advertising of claim 9, wherein said database comprises at least one consumer account.

12) The system for advertising of claim 9, wherein said database comprises an advertising content;
wherein said advertising content comprises said good or service provided by a participating business.
